(19) United States
(12) Patent Application Publication
(10) Pub. No.: US 2008/0096651 A1
(43) Pub. Date: Apr. 24, 2008

(54) Gaming machine

(75) Inventor: Kazuo Okada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/494,758

(22) Filed: Jul. 28, 2006

(51) Int. Cl. A63F 13/00

(52) U.S. Cl. 463/31

(57) ABSTRACT

A gaming machine includes: a projection unit that projects an image; an imaging unit on which the image projected by the projection unit is displayed; a position detection unit that detects a position pointed by a pointer on the imaging unit; a position settlement determination unit that determines whether or not a predetermined position settlement requirement is satisfied based on positional information indicating the position detected by the position detection unit; and a processor that controls progress of a game based on a result of a determination made by the position settlement determination unit.

### BACKGROUND OF THE INVENTION

1. Field of the Invention

The present invention relates to a gaming machine, and more particularly to a gaming machine which displays an image on, e.g., a screen, and when a player point a certain position in the displayed image, detects the position, wherein a progress of a game is controlled so that information related to game is not fixed while the player points at the same location or area.

2. Description of the Related Art

An apparatus which displays a porker table and a betting board by a monitor display to thus provide a game is available as a gaming machine to be installed in a game arcade or an amusement arcade. For instance, JP-A-2003-325726 and US 2005/0032570 A1 disclose a roulette machine that includes a roulette and displays a betting table which displays a number for betting on a monitor such as a liquid-crystal display device or a CRT monitor.

### SUMMARY OF THE INVENTION

In a gaming machine, such as a roulette machine or a card gaming machine, where plural players concurrently play games using a single table, the plural players point out desiring locations (e.g., locations where chips are bet) by their hands on the single table, as an actual roulette game or a card game, to thus cause the game to proceed.

When such a game is played, the players often vacillate over selection of one from plural subject of the bet (e.g., BANKER, PLAYER, TIE in a baccarat game) by the last moment. Further, there are many cases where a player who has once selected a subject of the bet changes his/her mind and attempts to bet on another subject of the bet or where the player strategically changes the subject of the bet after observing selections by other players.

According to an aspect of the present invention there is provided a gaming machine that controls a progress of a game without fixing information related to the game while the player points at the same location or area, so that a player can change a subject of the bet freely until the player makes a final decision about the subject of the bet.

According to another aspect of the invention, there is provided a gaming machine including: a projection unit (a liquid-crystal projector) that projects an image; an imaging unit (a translucent screen) on which the image projected by the projection unit is displayed; a position detection unit (a digital video camera, an infrared-ray sensor, or a touch panel) that detects a position pointed by a pointer on the imaging unit; a position settlement determination unit that determines whether or not a predetermined position settlement requirement is satisfied based on positional information indicating the position detected by the position detection unit; and a processor that controls progress of a game based on a result of a determination made by the position settlement determination unit.

According to the above configuration, the progress of the game may be controlled by preventing determination of information about a game while the player points at a single location or area, so that the player can freely change an subject of the bet until finally determining the subject of the bet.

According to still another aspect of the invention, there is provided a gaming machine including: a projection unit (a liquid-crystal projector) that projects an image; an imaging unit (a translucent screen) on which the image projected by the projection unit is displayed and a pointer shade image that is a shade of a pointer used by a player for pointing a desired position is formed; an image-capturing unit (a digital video camera) that captures the image and the pointer shade image on the imaging unit from an other side of the projecting unit with respect to the imaging unit and outputs image data indicating the image and the pointer shade image; a position detection unit that detects a position pointed by the pointer based on the pointer shade image included in the image data; a position settlement determination unit that determines whether or not a predetermined position settlement requirement is satisfied based on positional information indicating the position detected by the position detection unit; and a processor (a game control unit) that controls progress of a game based on a result of a determination made by the position settlement determination unit.

According to the above configuration, the imaging unit displays image and receives a user input. Hence, there may be provided a gaming machine which needs a simple configuration and can control the progress of the game by preventing determination of information about a game while the player points at a single location or area, so that the player can freely change an subject of the bet until the subject of the bet is finally determined.

According to a further aspect of the invention, there is provided a gaming machine including: a projection unit (a liquid-crystal projector) that projects an image for displaying a game table and medals; an imaging unit (a translucent screen) on which the image projected by the projection unit is displayed, the imaging unit including a display surface; a position detection unit (an infrared-ray sensor) that detects a position pointed by a pointer by scanning the display surface of the imaging unit; a position settlement determination unit that determines whether or not a predetermined position settlement requirement is required based on positional information indicating the position detected by the position detection unit; and a processor (a game control unit) that controls progress of a game based on a result of a determination made by the position settlement determination unit.

According to the above configuration, the imaging unit displays the image and receives a user input. Hence, there may be provided a gaming machine which needs a simple configuration and can control the progress of a game by preventing determination of information about a game while the player points at a single location or area, so that the player can freely change an subject of bet until the subject of a bet is finally determined.

The position settlement determination unit may store the position detected by the position detection unit, and determine that the predetermined position settlement requirement is satisfied when a position newly detected by the position detection unit is determined to coincide with the stored position. The processor may stop the progress of the game until the position settlement determination unit determines that the position settlement requirement is satisfied.

According to the above configuration, there can be embodied a gaming machine which ascertains that a bet position has not yet been determined while the hand remains at the same location and enables players to arbitrarily change the bet position.

According to the above configuration, there is provided a gaming machine having a bet position detection function of detecting bet positions on a game table displayed as an image, where players can change subjects of bets until they finally determine subjects, as in an actual casino, whereby the atmospherics and realism of the actual casino can be offered to the players.

### BRIEF DESCRIPTION OF THE DRAWINGS

Embodiments of the present invention will be described in detail based on the following figures, wherein:

FIG. 1 is a view showing an exemplary basic configuration of an image display system;

FIG. 2 is a view showing another exemplary basic configuration of the image display system;

FIG. 3 is a view showing still another exemplary basic configuration of the image display system;

FIG. 4 is a view showing yet another exemplary basic configuration of the image display system;

FIG. 5 is an external perspective view of the gaming machine according to a first embodiment utilizing the image display system;

FIG. 6 is a view showing an exemplary layout of an optical system constituting the gaming machine according to the first embodiment;

FIG. 7 is a view showing an exemplary electrical configuration of the gaming machine according to the first embodiment;

FIG. 8 is a view showing an exemplary screen displayed on a front display;

FIG. 9 is a view showing an exemplary screen displayed on a translucent screen of the gaming machine;

FIG. 10A is an exemplary image formed by capturing a rear image of the translucent screen;

FIG. 10B is an example screen formed by capturing a rear image of the translucent screen including a shadow;

FIG. 10C is a conceptual rendering obtained after the image data shown in FIG. 10B have been binarized;

FIG. 11A is a flowchart showing an exemplary operation of the gaming machine according to the first embodiment;

FIG. 11B is a flowchart showing an exemplary operation of position detection processing;

FIG. 11C is a view showing an exemplary image displayed on the table screen;

FIG. 11D is a view showing an exemplary image displayed on the table screen;

FIG. 11E is a view showing an exemplary image displayed on the table screen;

FIG. 11F is a view showing an exemplary image displayed on the table screen;

FIG. 12 is a block diagram showing an exemplary electrical configuration of the gaming machine according to a modification of the first embodiment;

FIG. 13 is an external perspective view of the gaming machine utilizing the image display system according to a second embodiment;

FIG. 14 is a view showing an exemplary layout of an optical system constituting the gaming machine according to the second embodiment;

FIG. 15 is a view showing an exemplary electrical configuration of the gaming machine according to the second embodiment;

FIG. 16A is a plan view of the gaming machine showing a scan area of a sensor;

FIG. 16B is a front view of the gaming machine;

FIG. 17 is a plan view of the gaming machine showing a scan area of the sensor when the player is specified;

FIG. 18 is a plan view of the gaming machine showing the scan area of the sensor when the player is specified;

FIG. 19 is a flowchart showing an exemplary principal operation of the gaming machine according to the second embodiment;

FIG. 20 is a view showing an exemplary layout of an optical system constituting the gaming machine of a third embodiment; and

FIG. 21 is a view showing an exemplary electrical configuration of the gaming machine of the third embodiment.

### DETAILED DESCRIPTION OF THE INVENTION

Embodiments of the present invention will be described hereinbelow with reference to the drawings.

### [1. First Mode of Implementation]

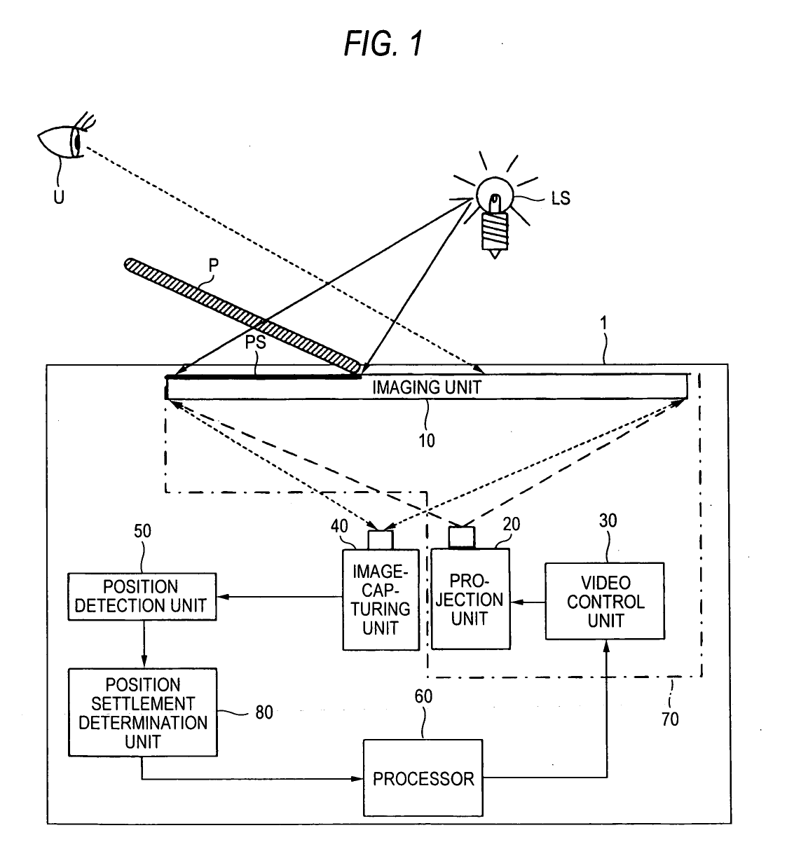

A first mode of implementation of the present invention will be described with reference to FIG. 1. FIG. 1 is a view showing an exemplary basic configuration of an image display system according to the first mode of the present invention.

This image display system 1 includes an imaging unit 10; a video control unit 30 that supplies image data; a projection unit 20 that projects an image on the front surface of the imaging unit 10 based on image data sent from the video control unit 30; an image-capturing unit 40 that captures the image of the imaging unit 10, from the rear thereof, on which a shadow PS of a pointer P is formed; a position detection unit 50 that receives image data pertaining to the back of the imaging unit 10 output from the image-capturing unit 40, determines the position of the shadow PS of the pointer P from the image data, and outputs positional information; a position settlement determination unit 80 that receives from the position detection unit 50 the positional information indicating the position pointed by the pointer P, determines if the positional information is settled positional information (hereinafter called “settled positional information”) or unsettled positional information (hereinafter called “unsettled positional information”), and outputs the result of determination to a processor 60; and the processor 60 that gives the video control unit 30 an instruction of an image to be displayed on the imaging unit 10, based on the determination result and the positional information output from the position settlement determination unit 80, to thus perform other processing pertaining to the progress and control of the entire game. The imaging unit 10, the projection unit 20, and the video control unit 30 constitute image display unit 70 that displays an image for a user or a player.

The imaging unit 10 is translucent and allows transmission of light from the front and back surfaces. The imaging unit 10 is, e.g., a translucent screen for a liquid-crystal projector. The translucent screen, which is the imaging unit 10, includes a screen which has a light-scattering layer and efficiently scatters light from the liquid-crystal projector, or the like, to thus display a light contrast image. When the imaging unit 10 is viewed from the front surface thereof, an optical image projected by the projection unit 20 from the back of the imaging unit 10 looks to be formed on the imaging unit 10. Consequently, the user U can view the image corresponding to the image data projected by the projection unit 20.

The pointer P is an object or means by which the user points out a desired location on the image appearing on the front surface of the imaging unit 10. For instance, the pointer P is the hand (including an arm portion) of the user U or a pointing rod. The pointer P is illuminated by a light source LS, and the shadow PS of the pointer P is formed on the imaging unit 10. Since the imaging unit 10 is translucent, the shadow PS is viewed even when the imaging unit 10 is viewed from back. The light source LS may be a natural light source such as sun or an illuminating device provided in the environment where the image display system 1 is installed. Alternatively, the light source LS may be an illuminating device such as a fluorescent lamp provided on the image display system 1.

The projection unit 20 is an optical projection system capable of projecting an optical image on the imaging unit 10 based on image data; and is, e.g., a liquid-crystal projector [DLP: (Digital Liquid Projector)]. The light source LS is preferably a light source which emanates white light. As a result of white light having passed through the imaging unit 10, the area of the shadow PS of the pointer P in the back of the imaging unit 10 is seen black, and the area other than the shadow PS is seen white, whereby an image equivalent to a monochrome image, or the like, is acquired.

The image-capturing unit 40 captures a rear image of the imaging unit 10 to thus generate rear image data pertaining to the imaging unit 10. The image-capturing unit 40 is, e.g., a digital camera, a digital video camera, a CCD camera unit, or the like.

The video control unit 30, the position detection unit 50, the position settlement determination unit 80, and the processor 60 correspond to an apparatus equipped with an arithmetic processor (CPU), main memory (RAM), read-only memory (ROM), an input/output device (I/O), and, as required, an external storage device such as a hard disk drive; for example, an information processing apparatus such as a computer, a workstation, or an LSI chip. A program used for causing the information processing apparatus to act as the video control unit 30, the position detection unit 50, the position settlement determination unit 80, or the processor 60, is stored in the ROM or the hard disk drive unit. This program is stored in the main memory, and the CPU executes the program, thereby implementing the video control unit 30, the position detection unit 50, the processor 60, or the position settlement determination unit 80. The program is not necessarily stored in the storage device provided within the information processing apparatus. There may also be adopted a configuration where the program is provided from an external device [e.g., the server of an ASP (application service provider)] and loaded into the main memory.

The video control unit 30, the position detection unit 50, the processor 60, and the position settlement determination unit 80 may be implemented from discrete information processors. Alternatively, a single information processor may be configured so as to function as a combination of any two of the video control unit 30, the position detection unit 50, the processor 60, and the position settlement determination unit 80.

The video control unit 30 stores image data to be displayed for the user; reads required image data in accordance with a command from the processor 60; subjects the thus-read image data to image processing as required; and provides the thus-processed image data to the projection unit 20.

The position detection unit 50 serving as detection means receives rear image data pertaining to the imaging unit 10 from the image-capturing unit 40; subjects the image data to required image processing to thus detect the position of the shadow PS of the pointer P; and outputs the thus-detected position as positional information. Image processing includes threshold processing for extracting the area of the shadow PS, edge detection for extracting the contour of the shadow PS, and the like. The position detection unit 50 generates positional information about the shadow PS by utilization of the shadow area obtained by threshold processing and edge detection and coordinate positional information about pixels of a contour line.

The position settlement determination unit 80 has the function of determining whether or not requirements for settling a position have been satisfied, based on the positional information output from the position detection unit 50.

For example, the following requirements are set as requirements for settling a position.

(1) The latest positional information output from the position detection unit coincides with the previous positional information.

(2) A predetermined period of time has elapsed.

(3) The shadow PS of the pointer P is not detected.

Requirement (1) corresponds to a case where the position settlement determination unit 80 does not determine that positional information is settled, when the player keeps pointing at the same position and handles the positional information as being indefinite information. Requirement (2) corresponds to a case where the player has previously set a period of time (e.g., one minute) during which the player selects a location on which a bet is to be made and a case where the latest positional information acquired after elapse of the time as settled position information. Requirement (3) corresponds to a case where, when the player has determined that the final bet position has been settled, the pointer P is withdrawn to a position where the shadow PS is not cast on the imaging unit 10 to thus fix positional information.

Appropriate combinations of these requirements (1) to (3) may also be taken as position settlement requirements. Alternatively, any requirements other than the requirements (1) to (3) can be used as position settlement requirements, by which the position settlement determination unit 80 makes a determination, so long as a determination can be made based on the positional information from the position detection unit 50. The requirements can be used as position settlement requirements by which the position settlement determination unit 80 makes a determination.

In the present embodiment, the position settlement determination unit 80 outputs the determination result to the processor 60 as settled position information or unsettled position information. For instance, when the determination result is formed from 8-bit data, a conceivable configuration is to assign an MSB (Most Significant Bit) to a flag which distinguishes settlement from unsettlement and to assign the other seven bits to positional information.

The processor 60 has the function of controlling the entire operation of the image display system 1; issues to the video control unit 30 a command pertaining to image data to be output and a timing at which image data are to be output; and sends to the video control unit 30 a command for changing the image data according to the settled positional information/unsettled positional information from the position settlement determination unit 80. The processor 60 performs predetermined processing upon receipt of the settled position information. However, upon receipt of the unsettled position information, the processor 60 does not perform predetermined processing. The predetermined processing includes, e.g., determination of a win or lose of a game and payment of an award for win.

### [2. Modification of First Mode of Implementation]

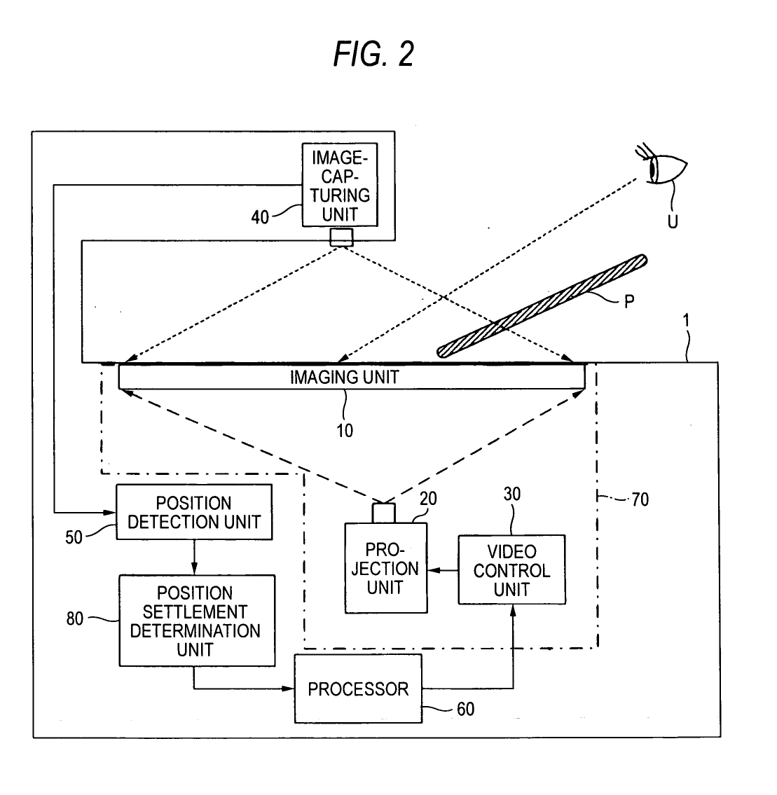

FIG. 2 shows a modification of the image display system 1 shown in FIG. 1. In the system shown in FIG. 1, the image of the position of the pointer P is captured from a position below the imaging unit 10, and the position is detected by use of the image including the shadow of the pointer P. In the modification shown in FIG. 2, the image-capturing unit 40 is placed at an elevated position over the imaging unit 10. The position is detected by directly capturing the image of the pointer P. Specifically, the image display system 1 according to the modification has a configuration for detecting the position by use of the real image of the pointer P in place of the shadow of the pointer P. The image display system can also be implemented by such a configuration.

### [3. Second Mode of Implementation]

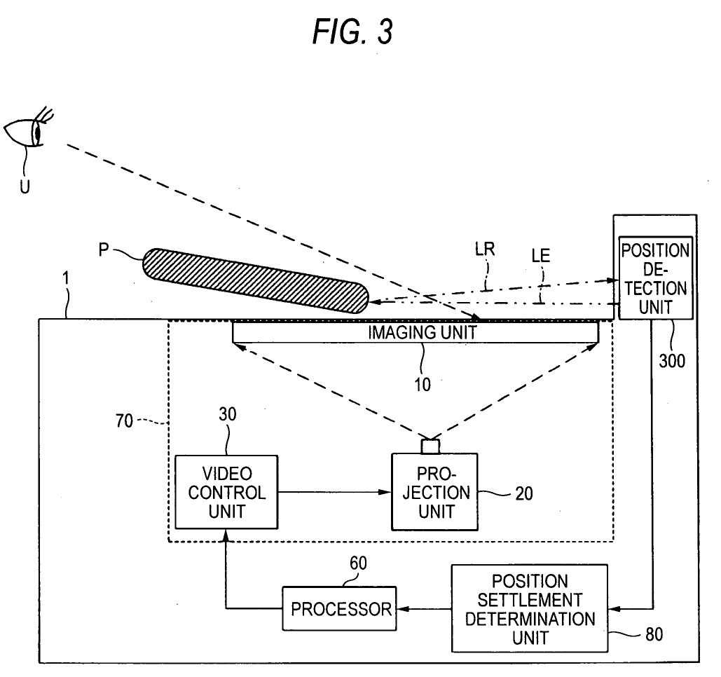

A second mode of implementation of the present invention will now be described with reference to FIG. 3. FIG. 3 is a view showing an exemplary basic configuration of an image display system according to the second mode.

This image display system 1 includes the imaging unit 10 constituting the image display unit 70; the video control unit 30 that supplies image data; a projection unit 20 that projects an image on the imaging unit 10 based on the image data from the video control unit 30; the position detection unit 300 that emanates light (beam) LE along a surface of the imaging unit 10 and that receives light LR reflected from the pointer P whose position is to be measured, to thus detect the position of the pointer P; the position settlement determination unit 80 that receives from the position detection unit 300 positional information indicating the position pointed by the pointer P, determines if the positional information is settled positional information or unsettled positional information, and outputs the result of determination to the processor 60; and the processor 60 that sends to the video control unit 30 a command of an image to be displayed on the imaging unit 10 based on the positional information from the position settlement determination unit 80. The imaging unit 10, the projection unit 20, and the video control unit 30 constitute the image display unit 70 that displays an image for a user of a player.

The imaging unit 10, the projection unit 20, the video control unit 30, the processor 60, and the position settlement determination unit 80 are analogous to their counterparts; namely, the imaging unit 10, the projection unit 20, the video control unit 30, the processor 60, and the position settlement determination unit 80 described in connection with the first mode. Accordingly, repeated their explanations are omitted here.

The position detection unit 300, which is a detection unit of the present mode, emanates directional light (emitted light) LE along the surface of the imaging unit 10, so as to scan the surface of the imaging unit 10; and receives the light LR which returns to the pointer P after having been reflected by the pointer P. The position detection unit has the function of: determining the direction and distance of the pointer P with reference to the position detection unit 300 based on the emanating direction of the emanated light LE and the amount of reflected light LR; determining the position of the pointer P from the direction and distance; and outputting positional information. The light emanated by the position detection unit 300 may be either visible light or invisible light, or electromagnetic waves whose wavelength does not belong to the range of so-called light. Alternatively, sound waves may also be used in stead of light.

### [Third Mode of Implementation]

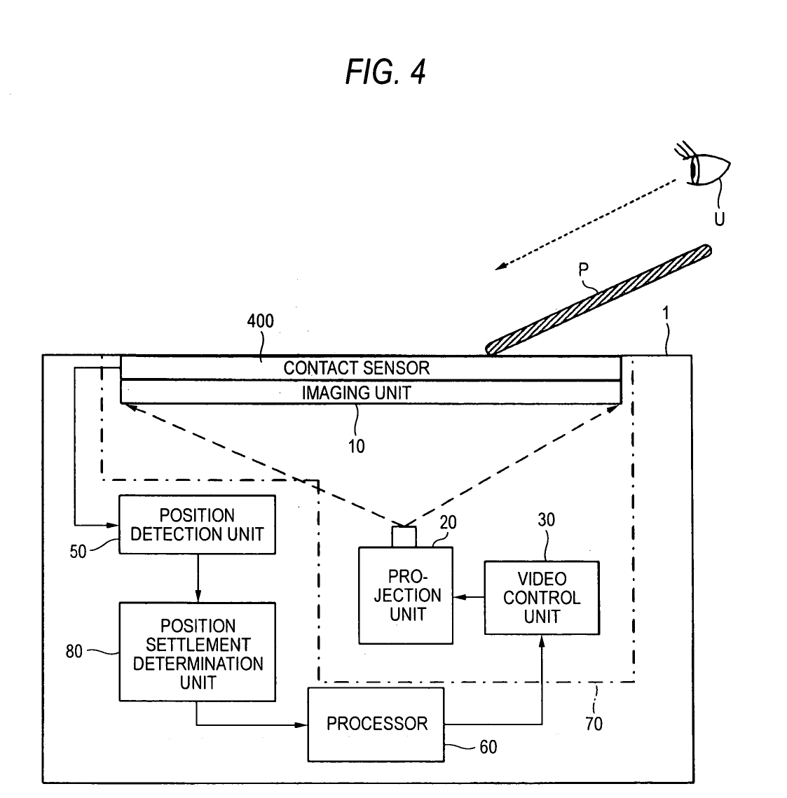

A third mode of implementation of the present invention will now be described with reference to FIG. 4. FIG. 4 is a view showing an exemplary basic configuration of an image display system according to the third mode.

This image display system 1 includes the imaging unit 10 constituting the image display unit 70; the video control unit 30 that supplies image data; the projection unit 20 that projects the image on a front surface of the imaging unit 10 based on the image data from the video control unit 30; a contact sensor 400 that detects a contact position of the pointer P; position detection unit 50 that generates positional information indicating the position pointed by the pointer P based on an output from the contact sensor 400; the position settlement determination unit 80 that receives from the position detection unit 50 positional information indicating the position pointed by the pointer P, determines if the positional information is settled positional information or unsettled positional information, and outputs the result of determination to the processor 60; and the processor 60 that sends to the video control unit 30 a command of an image to be displayed on the imaging unit 10 based on the positional information from the position settlement determination unit 80, to thus control progress in operation of the image display system 1. The imaging unit 10, the projection unit 20, and the video control unit 30 constitute the image display unit 70 which displays an image for a user or a player.

The imaging unit 10, the projection unit 20, the video control unit 30, the processor 60, and the position settlement determination unit 80 are analogous to their counterparts; namely, the imaging unit 10, the projection unit 20, the video control unit 30, the processor 60, and the position settlement determination unit 80 described in connection with the first mode. Accordingly, repeated their explanations are omitted here.

The contact sensor 400 serving as detection unit detects a contact position when the pointer P has contacted the surface of the contact sensor 400. For instance, the contact sensor is a pressure-sensitive touch panel or an electrostatic touch panel.

### EMBODIMENTS

Embodiments of the present invention will be described.

### 1. First Embodiment

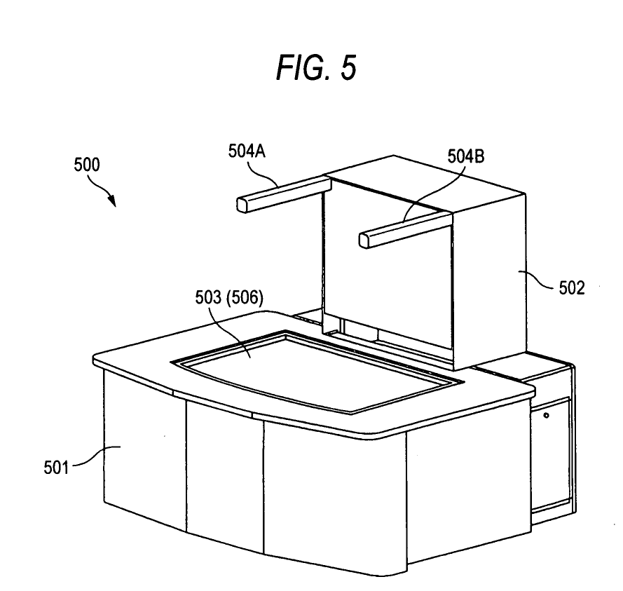

FIG. 5 is an external perspective view of a gaming machine utilizing the image display system 1 according to the embodiment of the present invention. The gaming machine will be described herein as an apparatus for causing the user to play a baccarat game. However, the gaming machine of the present embodiment is not limited to a baccarat game, but may be used for any games, such as a poker, a blackjack, a bridge, a roulette, and the like, which allow application of the image display system 1 of the embodiment.

A gaming machine 500 of the present embodiment has a table unit 501 and a front display unit 502 disposed at a rear position on the upper surface of the table unit 501.

The table unit 501 stores an optical system and information processing equipment, which constitute the image display system 1. An aperture is formed in an upper center of the table unit 501. A translucent screen 503 acting as the imaging unit 10 is affixed to the aperture. The translucent screen 503, a DLP 602, and a screen display control unit 701 function as an upper surface display (hereinafter called a “table screen 506”) corresponding to the image display unit 70 that displays a game image for a user. The upper surface of the translucent screen 503 is protected with a transparent plate member, such as a glass panel. Even when the player touches the table screen 506 with the hand that corresponds to the pointer P, the translucent screen 503 is not torn or stained.

Fluorescent lamps 504A, 504B, which act as the light source LS, are provided at upper both ends of the front display unit 502, and the shadow PS of the pointer P is cast on the translucent screen 503. The layout and positions of the fluorescent lamps 504A, 504B are not necessarily as shown in FIG. 5. The fluorescent lamps 504A, 504B may be disposed in any arrangement and at any positions, so long as the shadow PS of the pointer P is cast on the translucent screen 503. Moreover, the fluorescent lamps 504A, 504B may be omitted, so long as lighting, which casts the shadow PS of the pointer P on the translucent screen 503, is provided at a location where the gaming machine 500 is to be installed.

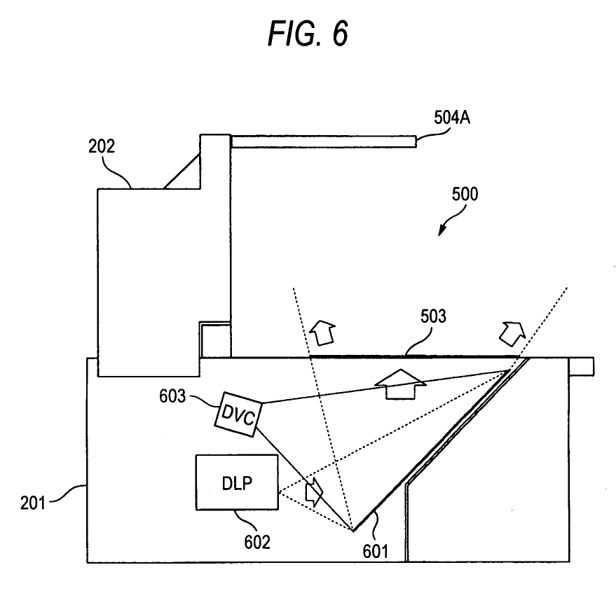

FIG. 6 is a view showing an example layout of an optical system constituting the image display system 1 stored in a table unit 501.

The translucent screen 503 is fixed in the center of the table unit 501 while being protected with a glass plate. A mirror 601 is provided in an inclined manner at a position below the translucent screen 503. A digital liquid-crystal projector (hereinafter abbreviated as a “DLP”) 602 corresponding to the projection unit 20 and a digital video camera (hereinafter abbreviated as “DVC”) 603 corresponding to the image-capturing unit 40 are fixed at positions opposing the mirror 601. The distance of the mirror 601 to the DLP 602 and the angle of a reflection plane of the mirror 601 are adjusted such that the mirror 601 reflects the image projected by the DLP 602 toward the translucent screen 503 to thus display the image in a desired size. Similarly, the mirror 601 is placed after the distance of the mirror 601 to the DVC 603 and the angle of the reflection plane of the mirror with respect to the translucent screen 503/the DVC 603 have been adjusted so that the rear image of the translucent screen 503 is reflected toward the DVC 603 and the DVC 603 can acquire the rear image of the translucent screen 503.

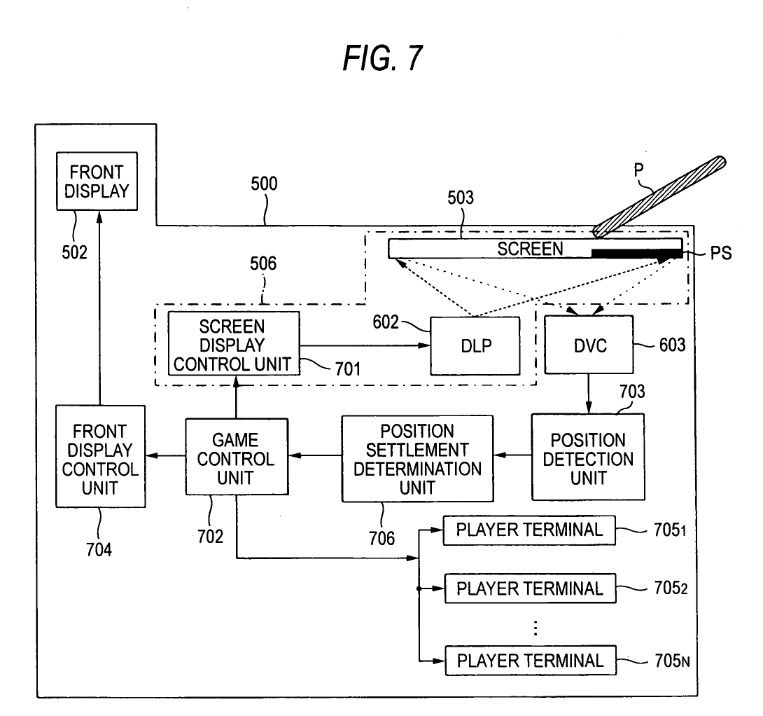

Next, an exemplary electrical configuration of the gaming machine 500 will be described. FIG. 7 is a block diagram showing an exemplary electrical configuration of the gaming machine 500.

As shown in FIG. 7, the gaming machine 500 is provided with a translucent screen 503. The DLP 602 optically projects an image pertaining to a game on the translucent screen 503. The screen display control unit 701, which corresponds to the video control unit 30, supplies image data (hereinafter called “front image data”) to the DLP 602. The DVC 603 captures a rear image of the translucent screen 503 and outputs image data (hereinafter called “rear image data”) that have been obtained by capturing of the rear image of the translucent screen 503.

By processing the rear image data, a position detection unit 703, which corresponds to the position detection unit 50, detects the position at the pointer P points, and outputs positional information.

A position settlement determination unit 706, which corresponds to the position settlement determination unit 80, receives the positional information output from the position detection unit 703; and determines whether or not predetermined position settlement requirements have been satisfied. Settled position information or unsettled position information is output as a result of determination to the game control unit 702. In the embodiment, the predetermined position settlement requirements are based on the assumption that previous positional information and the newly-received positional information do not indicate the same position. Namely, the positional information is not determined while the player points at a single position with the pointer P. The term “same position” does not always require a coincidence between coordinates. Even in a case where the previous positional information and the newly-received positional information do not coincide with each other in terms of coordinates but belong to a single area (e.g., a circle which is centered at the previous positional information and has a radius of 30 cm, or a single bet area such as a “TIE,” “BANKER,” “PLAYER,” or the like), both pieces of positional information may be handled as belonging to the same position.

The game control unit 702, which serves as the processor 60, has the function of controlling operation of the gaming machine 500; issues to the screen display control unit 701 a command pertaining to image data to be output and a timing at which image data are to be output; receives settled position information/unsettled position information from the position settlement determination unit 706; and controls operation of the gaming machine 500 based on the settled position information/unsettled position information.

Based on the settled position information/unsettled position information, the game control unit 702 displays a medal as an image which shows that the player has placed a bet at the position indicated by the positional information. Handling the image of a medal in a different manner, such as displaying an image of a medal in a highlighted manner or in a blinking manner, may be adopted as a display method for distinguishing settled position information from unsettled position information.

When having received the settled position information, the game control unit 702 causes a game to proceed. More specifically, the game control unit 702 performs processing for determining a win or lose of the game; determines a payout of an award/collection of medals based on the result of determination of the game; and re-calculates medals or credits owned by the player, to thus prepare for initiation of the next game. When having received the unsettled positional information, the game control unit 702 displays only an image of a medal without causing the game to proceed, and awaits fulfillment of the position settlement requirements. For example, the player is assumed to directly place his hand—corresponding to the pointer P—at a certain bet position (“BANKER” area herein) immediately after initiation of the game and to consider whether to select another bet point, without moving his hand. In this case, the position settlement determination unit 706 outputs unsettled position information. Hence, the game control unit 702 does not ascertain that the player has placed a bet at the BANKER area. Although the image of the medal is displayed in this area, there is performed processing for determining a win or loss of the game; a determination is made as to whether an award is paid or a medal is collected, based on the thus-determined win or loss, and the medals or credits owned by the player are not re-calculated.

In accordance with the command from the game control unit 702, the front display control unit 704 outputs image data (hereinafter called “front image data”) pertaining to an image to be displayed on the front display 502. The front display 502 receives the front image data and displays them. The image displayed on the front display 502 informs the user of status and progress of the game, and the like, in conjunction with the image appearing on the translucent screen 503.

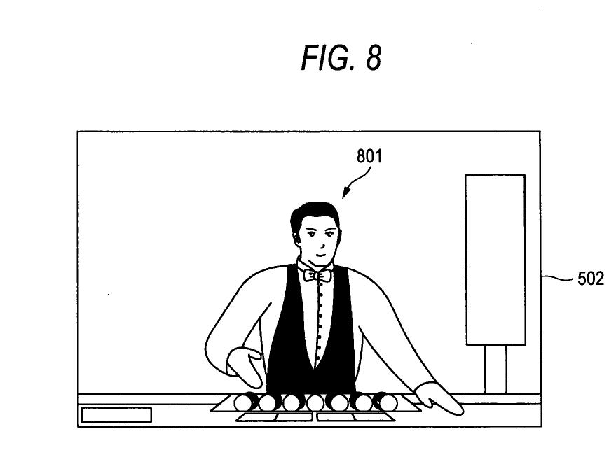

In the present embodiment, a dealer of the baccarat appears on the front display 502 in the form of a motion picture. FIG. 8 is an example screen displayed on the front display 502. A dealer 801 is displayed on the screen, and delivery and draw of cards and receipt of chips are displayed in accordance with progress of the game. Presentation is effected as if the players were playing the baccarat game with an actual dealer.

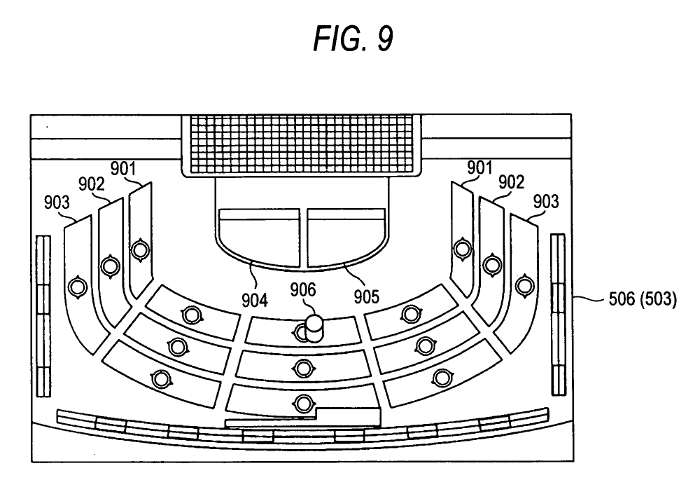

Next, an exemplary screen appearing on the table screen 506 (the translucent screen 503) is provided. FIG. 9 is an exemplary screen appearing on the table screen 506 of the gaming machine 500. In this embodiment, a screen imitating the baccarat table appears on the table screen 506. In the baccarat table shown in connection with this embodiment, areas 901, 902, and 903 respectively used for placing a bet in “TIE,” “BANKER,” and “PLAYER” are displayed for each of five players. The player points at any of the areas 901, 902, and 903 by his/her hand corresponding to the pointer P, whereupon the area pointed at, where the player places a bet, among the areas “TIE,” “BANKER,” and “PLAYER” is input to the gaming machine 500. The player can determine the number of chips/the amount of money/the number of credits to be bet by a bet button of a player terminal unit 705 to be described later. Piles of chips 906 owned by the respective players are also displayed on the table screen 506. When the player points at any of the areas “BANKER,” “PLAYER,” and “TIE,” where a bet is placed, by the pointer P, the image appearing on the table screen 506 is changed such that the chips, which are equal in number to the bet, are moved from the piles of chips of the player to the specified one of the areas 901, 902, and 903.

The table screen 506 has areas 904, 905 where the dealer 801 delivers cards for BANKER and PLAYER, and images of cards are displayed in these areas 904, 905.

Turning back to FIG. 7, explanation of the exemplary electrical configuration of the gaming machine 500 will be continued.

The game control unit 702 is connected to a plurality of player terminals 705₁ to 705_{N}, which respectively correspond to command receipt unit. Each of the player terminals 705 is a terminal machine having a bill delivery function of enabling the player to accept coins, paper money, a pre-paid card or a credit card, to make the card handleable as credits (medals/coins) to be used in the gaming machine 500, and to pay out credits (medals/coins) owned at that point in time in accordance with the payout command from the user and a bet input function of determining the number of bets/amounts of money/number of credits bet in the game. The player plays a game by the player terminal 705 and the pointer P.

Next will be described processing for detecting the position of the player's hand, which corresponds to the pointer P, from the rear image data pertaining to the rear of the translucent screen 503.

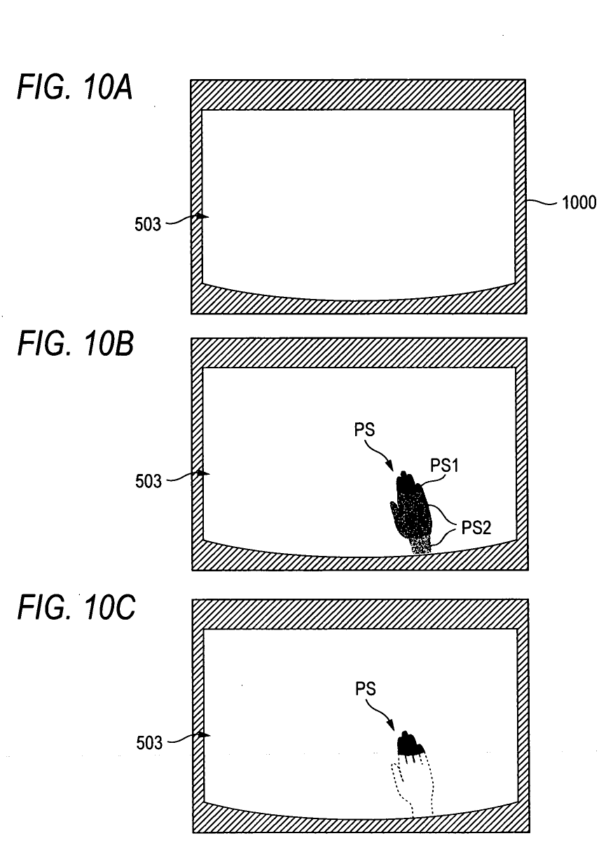

FIG. 10A shows an exemplary image obtained by the DVC 603 capturing the rear image of the translucent screen 503 by way of the mirror 601 when the shadow PS of the pointer P is not formed on the translucent screen 503. The DVC 603 is adjusted so as to capture an image of a surrounding 1000 of the translucent screen 503, as well as to capture the image of the translucent screen 503. The surrounding 1000 is a fixed frame used for fixing, e.g., the translucent screen 503, to the top board of the table unit 201, and is desirably colored in black or a dark color close to black.

When viewed with the naked eye, the image to be displayed on the front of the translucent screen 503, such as that shown in FIG. 9, is often thinly viewed from the rear thereof. For this reason, the exposure of the video camera 603 is adjusted such that the image displayed on the front of the translucent screen 503 is blurred in white. When the video camera 603 has an automatic exposure adjustment function, exposure is adjusted in tune with the surrounding 1000 colored in black or a dark color close to black. Hence, the image to be displayed on the front of the translucent screen 503 can be automatically eliminated without involvement of any particular exposure adjustment.

FIG. 10B shows an exemplary image obtained by the DVC 603 capturing the rear image of the translucent screen 503 by way of the mirror 601 while the shadow PS of the pointer P is formed on the translucent screen 503. In this image, the shadow PS of the hand, corresponding to the pointer P, is formed on the translucent screen 503. In this embodiment, the shadow PS includes a main shadow PS1, which is a dark shadow, and a semi-shadow PS2, which is a dim shadow. The main shadow PS1 and the semi-shadow PS2 differ from each other in terms of a distance to the translucent screen 503. The shadow of a front portion (finger-side) of the hand closer to the translucent screen 503 forms the main shadow PS1, and the shadow of a rear portion (arm-side) of the hand distant from the translucent screen 503 forms the semi-shadow PS2. The extremity of the pointer P can be discerned by a difference in shades of the shadows.

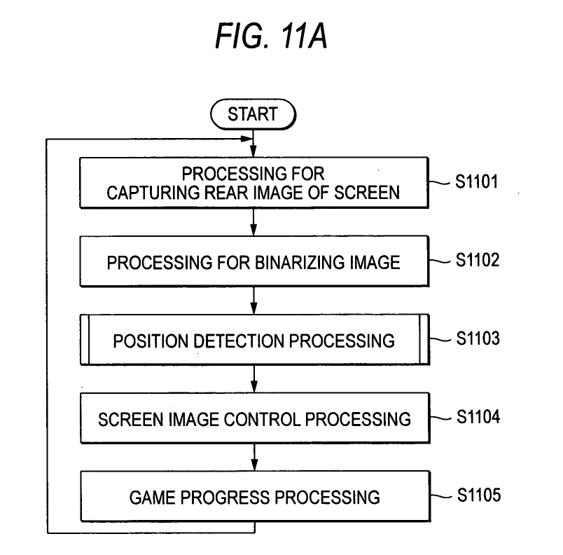

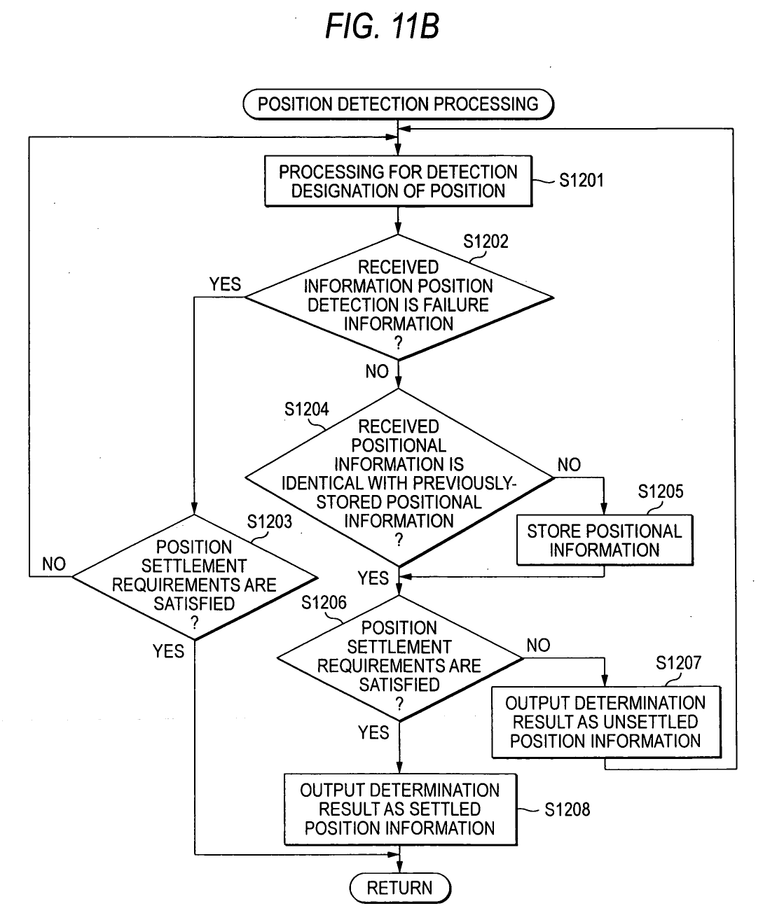

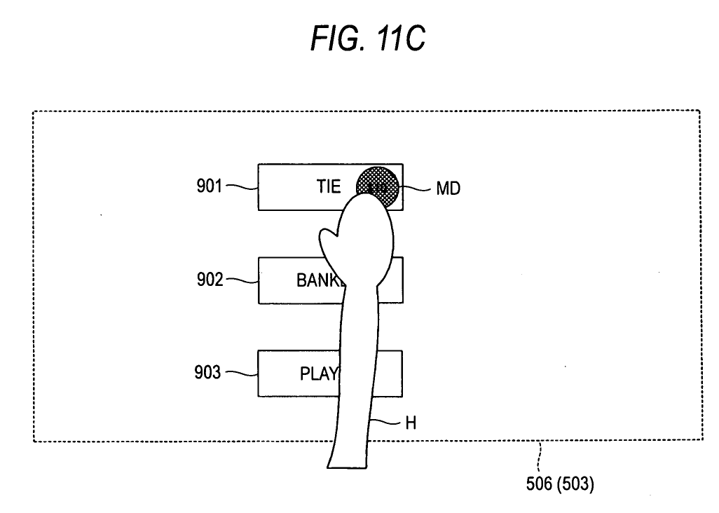

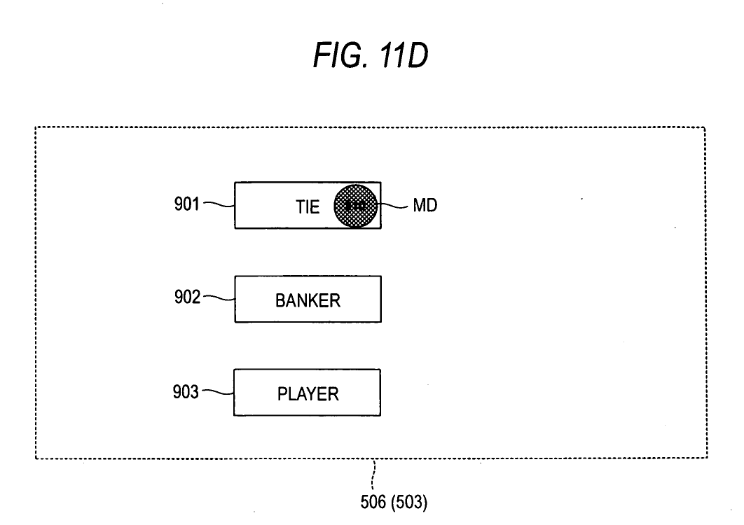

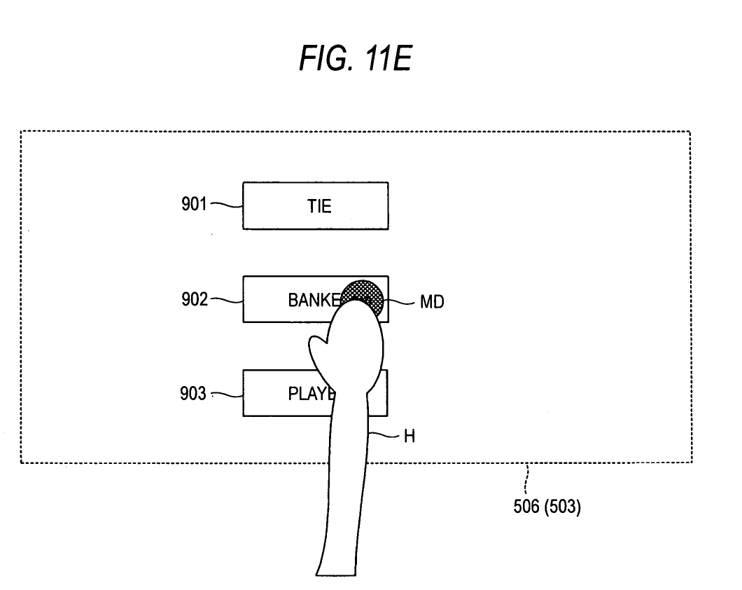

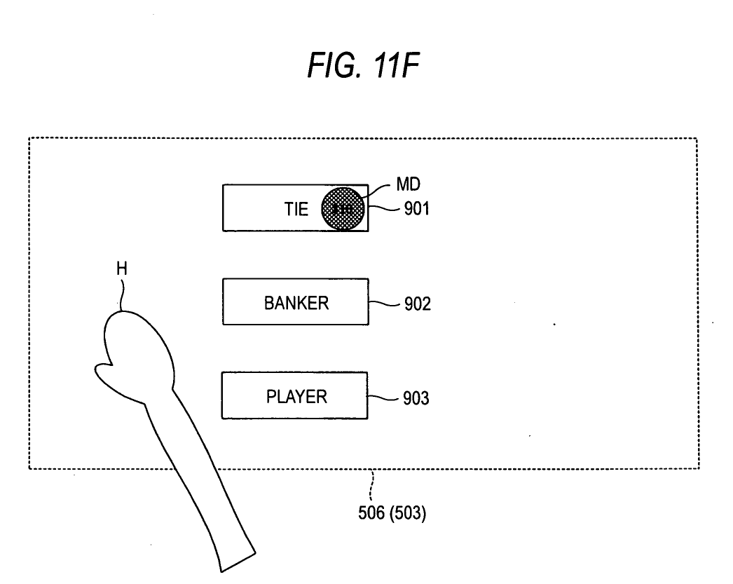

FIG. 11A is a flowchart showing exemplary main operation of the gaming machine 500.

First, the gaming machine 500 performs screen rear image capturing processing (step S1101). Specifically, the DVC 603 captures the rear image of the translucent screen 503 by way of the mirror 601, and outputs the image, such as that shown in FIG. 10B, to the position detection unit 703 as rear image data.

Upon receipt of the rear image data, the position detection unit 703 binarizes the rear image data (step S1102). FIG. 10C is a conceptual rendering of a case where binarized rear image data are displayed. In relation to the shadow PS of the pointer P, a dim portion of the shadow, such as the semi-shadow PS2, is discarded, to thus leave the extremity portion of the pointer P. Thus, the location at which the pointer P points becomes clear. When binarization processing is performed, an appropriate threshold value is set so that the extremity of the pointer P can be specified. An appropriate threshold value changes in accordance with the surroundings of the gaming machine 500 (the brightness of surrounding lighting, or the like). A working test is conducted after installation of the gaming machine 500, to thus seek an appropriate value.

Next, the position detection unit 703 performs position detection processing by use of the binarized rear image data (step S1103). FIG. 11B is a flowchart showing an exemplary embodiment of position detection processing. An embodiment of position detection processing (step S1103) will be described with reference to FIG. 11B.

When position detection processing has been commenced, the position detection unit 703 first acquires coordinate values (x, y) values of pixels having black values from the binarized rear image data, and generates positional information based on the thus-acquired coordinate values to thus perform position designation detection processing (step S1201). The positional information to be output may be coordinate values of pixels which form the vertex of the extremity. Alternatively, it is better to select an average or median value of coordinate values of all pixels having black values which correspond to the shadow PS. The position detection unit 703 outputs the positional information generated in step S1103 to the position settlement determination unit 706. If the shadow PS is not present, the position detection unit 703 outputs position detection failure information showing that the position on the table screen at which the pointer P points has not been detected.

The position settlement determination unit 706 determines whether or not the information received from the position detection unit 703 corresponds to position detection failure information (step S1202). When the positional information received from the position detection unit 703 is the position detection failure information (Yes in step S1202), the position settlement determination unit 706 determines whether or not the position settlement requirements have been satisfied (Yes in step S1203). When the position settlement requirements are satisfied (Yes in step S1203), position detection processing (step S1103) is completed, and processing proceeds to image display processing (step S1104 in FIG. 1A). When the position settlement requirements have not been satisfied (No in step S1203), processing returns to step S1201 where position designation detection processing is again performed.

When the information received from the position detection unit 703 in step S1202 is not the position settlement detection information (No in step S1202); namely, when the position settlement determination unit 706 has received positional information, the position settlement determination unit 706 determines whether or not coincidence exists between the previously-stored positional information and the received positional information (step S1204).

When no coincidence is determined to exist between the previously-stored positional information and the received positional information (including a case where no positional information has previously been stored) through determination processing pertaining to step S1204 (No in step S1204), the received positional information is stored as new positional information (step S1205). Subsequently, processing proceeds to determination processing pertaining to step S1206 which will be described below. The new positional information may be stored by replacement with the previously-stored positional information or stored separately from the previously-stored positional information such that a time sequence is ascertained.

When the previously-stored positional information is determined to coincide with the received positional information by determination processing pertaining to step S1204 (Yes in step S1204), the position settlement determination unit 706 determines whether or not the position settlement requirements have been satisfied (step S1206). When the position settlement requirements are satisfied (Yes in step S1206), the position settlement determination unit 706 outputs the stored positional information (the latest positional information when a plurality of pieces of positional information are stored) as settled position information (step S1208). Position detection processing (step S1103) is completed, and processing proceeds to image display processing (step S1104 in FIG. 1A). Meanwhile, when the position settlement requirements have not been satisfied (No in step S1206), the position settlement determination unit 706 outputs, as unsettled position information, the stored positional information (the latest positional information when a plurality of pieces of positional information are stored) (step S1207). Subsequently, processing returns to step S1201, where position designation detection processing is again performed.

Turning back to FIG. 11A, description of the example principal operation of the gaming machine 500 is continued.

When position detection processing (step S1103) has been completed and when the game control unit 702 has received the settled positional information or the unsettled positional information from the position settlement determination unit 706, the game control unit 702 performs screen image control processing based on the settled positional information/unsettled positional information (step S1104). Based on the settled positional information/unsettled positional information, the game control unit 702 sends to the screen display control unit 701 a command about the location where the image of the medals is to be displayed. In response to this command, the screen display control unit 701 generates required image data, and the DLP 602 projects the image data onto the translucent screen 503.

Upon receipt of the settled position information, the game control unit 702 performs required game progress processing (step S1105). Specifically, in accordance with the received positional information and the received player's command, the game control unit 702 determines the amount of a bet placed by the player; causes the game to proceed to thus determine a win or loss of the game for the player; and pays out medals as an award or collects medals in accordance with the win or loss. Thus, the game ends. Subsequently, processing again returns to step 1101, where the next new game is commenced.

Upon receipt of the settled positional information, the game control unit 702 again returns to step 1101 without performing processing for causing a game to proceed, thereby continuing the game that is currently being carried out.

Example operation of the gaming machine 500 will now be described with reference to FIGS. 11C to 11F. FIGS. 11C to 11F are views of the table screen 506 when viewed from above, showing an area in the table screen 506 used by a certain player.

FIG. 11C shows a portion of the table screen 506 including bet areas of the certain player; namely, the “TIE” area 901, the “BANKER” area 902, and the “PLAYER” area 903. Although the table screen 506 displays the areas 901 to 903 for other players, they are omitted from FIG. 1C.

In the embodiment shown in FIG. 11C, the hand H, corresponding to the pointer P, of the player is stretched over the table screen 506 so as to point at the “TIE” bet area 901. The player keeps pointing at the “TIE” bet area 901. On the assumption that the gaming machine 500 is given the position settlement requirements; namely, nonoccurrence of a state where the pointer does not point at the same position during a predetermined period of time, the gaming machine 500 ascertains the “TIE” bet area 901 as unsettled position information. Although the gaming machine 500 displays the medals MD in the “TIE” bet area 901 so as to show the bet position to the player, the game is not caused to proceed, and determination of a win or loss and adjustment of acquired/confiscated medals are not carried out.

In FIG. 11D, when a predetermined period of time has elapsed since the player has withdrawn his/her hand H, corresponding to the pointer P, from the table screen 506, the gaming machine 500 determines that the previously-described position settlement requirements; namely, nonoccurrence of a state where the pointer points at the same position during a predetermined period of time, are satisfied. The gaming machine 500 ascertains the “TIE” bet area 901 as settled position information; causes the game to proceed; determines a win or a loss and adjusts acquired/confiscated medals; and initiates the next game.

The embodiment shown in FIG. 11E corresponds to a state where the player moves his hand H to the “BANKER” bet area 902 before lapse of a predetermined period of time after the state shown in FIG. 11C, and keeps pointing at the “BANKER” bet area 902. From the state where the player keeps pointing at the “BANKER” bet area 902, the gaming machine 500 determines that the position settlement requirements; namely, nonoccurrence of a state where the pointer points at the same position during a predetermined period of time, are not satisfied. The gaming machine 500 cancels the display of the medal MD appearing on the “TIE” bet area 901 showing the previous unsettled positional information; ascertains the “BANKER” bet area 902 as new unsettled positional information; and displays the medal MD in the “BANKER” bet area 902 so as to show the bet position to the player. As in the case of the embodiment shown in FIG. 11C, the gaming machine 500 remains in a standby condition without causing the game to proceed, determining a win or a lose, and adjusting acquired/confiscated medals.

Another conceivable position settlement requirement is “non-occurrence of a state where the pointer points at any of the bet areas 901 to 903 during a predetermined period of time.” FIG. 11F shows that the player has moved his hand H from the “TIE” bet area 901 to a location where none of the bet areas 901 to 903 are pointed at after the state shown in FIG. 11C and still keeps the hand H at that position. The gaming machine 500 determines that the position settlement requirement “nonoccurrence of a state where the pointer points at any of the bet areas 901 to 903 during a predetermined period of time” has been satisfied. The gaming machine 500 ascertains the “TIE” bet area 901 as settled position information; causes the game to proceed; determines a win or a loss; adjusts the acquired/confiscated medals; and subsequently commences the next game.

### [Modification of the Gaming Machine]

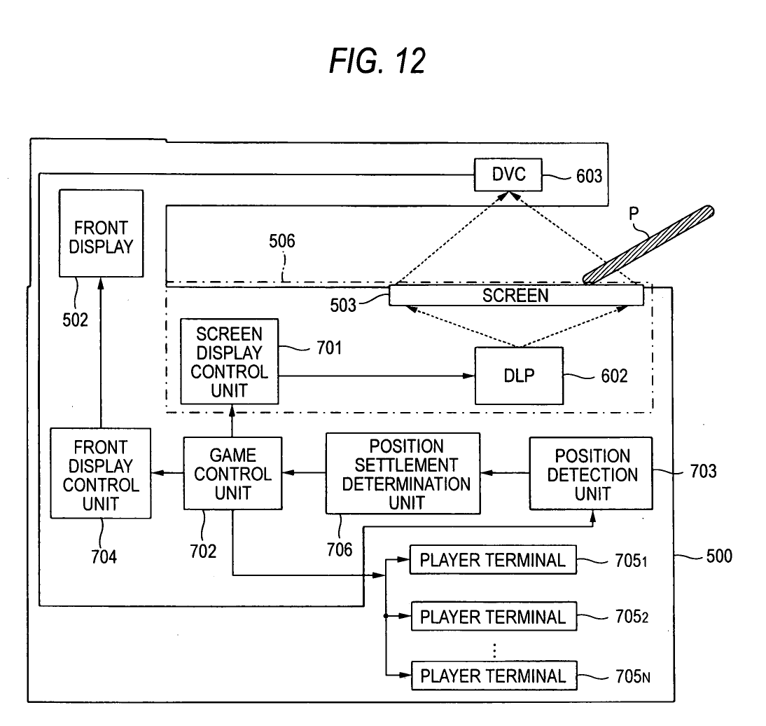

FIG. 12 shows a modification of the gaming machine 500. In this modification, the DVC 603 captures an image, including an actual image, of the pointer P from above the table screen 506 rather than the shadow of the pointer P. The position detection unit 703 detects from the actual image the position at which the pointer P points. In terms of the other constituent elements and the other operations, the gaming machine is identical with the gaming machine 500 shown in FIG. 7.

### 2. Second Embodiment

A second embodiment of the present invention will now be described.

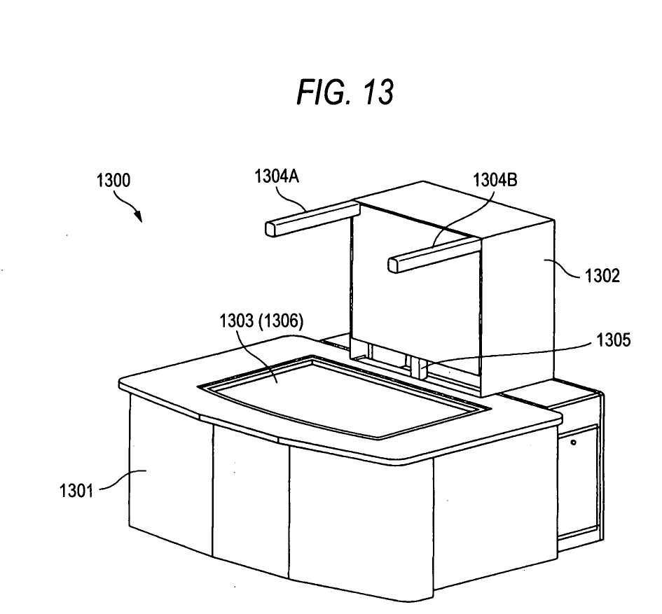

FIG. 13 is an external perspective view of a gaming machine utilizing the image display system 1 according to the second embodiment. The gaming machine is described as a device for causing the player to play a baccarat game. However, the gaming machine of the present embodiment is not limited to the baccarat game but may be applied to any games, such as poker, blackjack, bridge, roulette, a soccer game, an American football game, an RPG, an action game, and the like, so long as the image display system 3 of the present embodiment can be applied to the game.

A gaming machine 1300 of the present embodiment has a table unit 1301, and a front display 1302 disposed at a rear position on the table unit 1301.

The table unit 1301 houses an optical system and information processing equipment, which constitute the image display system 3. An aperture is formed in the center of the upper surface of the table unit 1301. A translucent screen 1303 corresponding to the imaging unit 10 is affixed to the aperture. The translucent screen 1303, a DLP 1402, and a screen display control unit 1501, which will be described later, function as an upper surface display (hereinafter also called a “table screen 1306”) corresponding to the image display unit 70 that displays a game image for the user. The upper surface of the translucent screen 1303 is protected with a transparent plate member, such as a glass panel. Even when the player touches the upper display with his hand, which corresponds to the pointer P, the translucent screen 1303 is not torn or stained.

Fluorescent lamps 1304A, 1304B are provided at both upper ends of the front display 1302. The layout and positions of the fluorescent lamps 1304A, 1304B are not necessarily as shown in FIG. 13. The fluorescent lamps 1304A, 1304B may be disposed in any arrangement and at any positions. Moreover, the fluorescent lamps 1304A, 1304B may be omitted, so long as the player can visually ascertain an image appearing on the table screen 1306 and the front display 1302 at the location where the gaming machine 1300 is installed.

A sensor 1305 corresponding to a position detection unit 300 is provided at a center lower position on the front display 1302. The sensor 1305 is, e.g., a photoelectric sensor for detecting obstacles (PB9 series available from Hokuyo Automatics Co., Ltd.) or a laser sensor. The sensor 1305 is not limited to the layout and position such as that mentioned above and may be placed in any location and layout, so long as the sensor can emit a scan light over the surface of the translucent screen 1303, corresponding to the table screen 1306, to thus scan the upper surface of the translucent screen 1303.

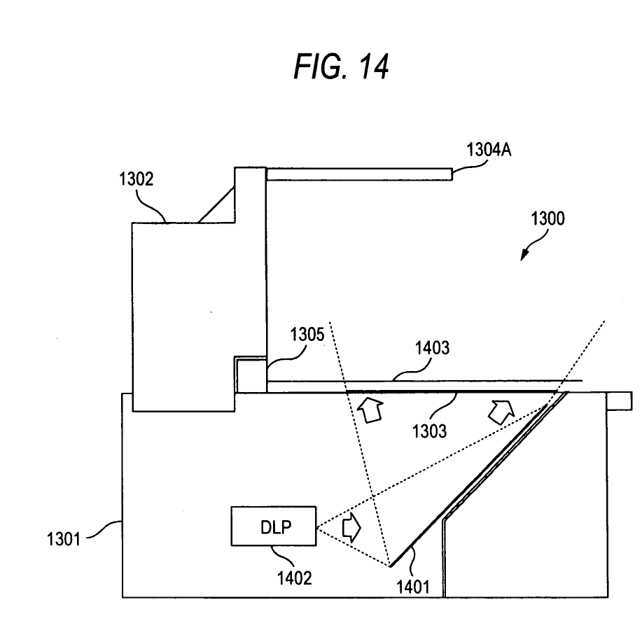

FIG. 14 is a view showing an exemplary layout of an optical system constituting the image display system 1 stored in the table unit 1301.

The translucent screen 1303 is fixed in the center of the table unit 1301 while being protected with a glass plate. The mirror 1401 is provided in an inclined manner at a position below the translucent screen 1303. The digital liquid-crystal projector (hereinafter abbreviated as “DLP”) 1402 corresponding to the projection unit 20 is disposed at the position opposite the mirror 1401. The distance from the mirror 1401 to the DLP 1402 and the angle of a reflection plane of the mirror 1401 are adjusted such that the mirror 1401 reflects the image projected by the DLP 1402 toward the translucent screen 1303 to thus display the image in a desired size.

The sensor 1305 is disposed on the upper surface of the table unit 1301 so that the upper surface of the translucent screen 1303 can be scanned by the scan light 1403.

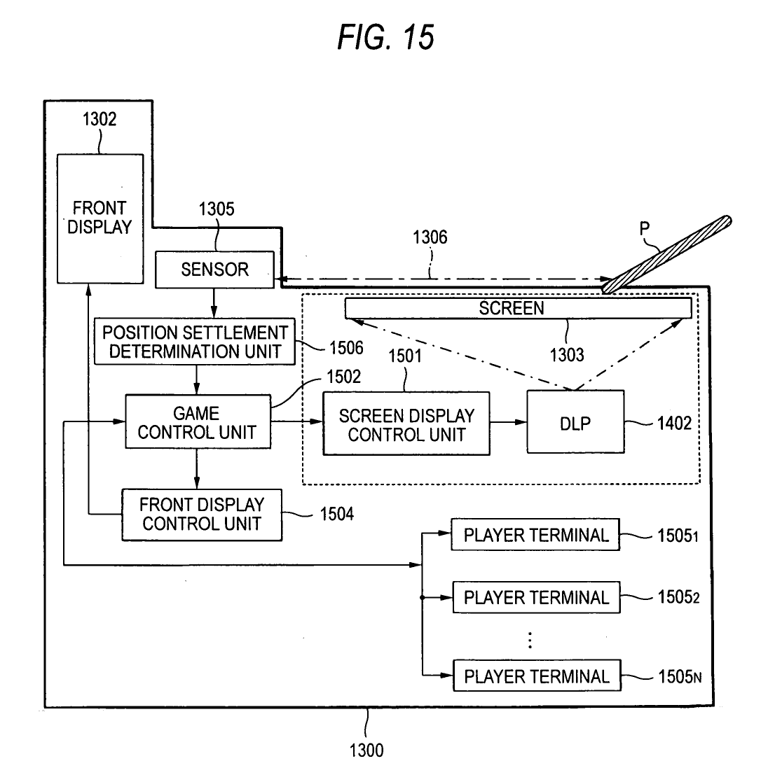

Next, an exemplary electrical configuration of the gaming machine 1300 will be described. FIG. 15 is a block diagram showing an exemplary electrical configuration of the gaming machine 1300.

As shown in FIG. 15, the gaming machine 1300 is provided with a translucent screen 1303.

The DLP 1402 optically projects an image pertaining to a game on the translucent screen 1303.

The screen display control unit 1501, which corresponds to the video control unit 30, supplies image data (hereinafter called “front image data”) to the DLP 1402. The translucent screen 1303, the screen display control unit 1501, and the DLP 1402 constitute the table screen 1306 corresponding to the image display unit 70.

The sensor 1305 detects the position at which the pointer P points and outputs positional information.

A position settlement determination unit 1506, which corresponds to the position settlement determination unit 80, receives the positional information output from the position detection unit 1503; determines whether or not predetermined position settlement requirements have been satisfied; and outputs settled position information or unsettled position information as a result of determination to the game control unit 1502. In the present embodiment, the predetermined position settlement requirements are based on the assumption that previous positional information and the newly-received positional information do not indicate the same position. Namely, the positional information is not determined while the player points at a single position with the pointer P. The term “same position” does not always require a coincidence between coordinates. Even in a case where the previous positional information and the newly-received positional information do not coincide with each other in terms of coordinates but belong to a single area (e.g., a circle which is centered at the previous positional information and has a radius of 30 cm or a single bet area such as “TIE,” “BANKER,” “PLAYER,” or the like), both pieces of positional information may be handled as belonging to the same position.

The game control unit 1502, which serves as the processor 60, has the function of controlling operation of the gaming machine 1300; issues to the screen display control unit 1501 a command pertaining to image data to be output and a timing at which image data are to be output; receives settled position information/unsettled position information from the sensor 1305; and controls operation of the gaming machine 1300 based on the positional information.

In accordance with the command from the game control unit 1502, the front display control unit 1504 outputs image data (hereinafter called “front image data”) pertaining to an image to be displayed on the front display 1302. The front display 1302 receives the front image data and displays them. The image displayed on the front display 1302 informs the user of the status and progress of the game, and the like, in conjunction with the image appearing on the translucent screen 1303. In the present embodiment, the dealer 801 of the baccarat, such as that shown in FIG. 8, appears on the front display 1302 in the form of a motion picture, as in the case of the first embodiment.

The image appearing on the front display 1302 may be controlled based on the positional information detected by the sensor 1305. For instance, the dealer 801 displayed on the front display 1302 is displayed such that the face and body of the dealer are changed so as to directly oppose the position in accordance with the positional information.

As in the case of the first embodiment, the screen such as that shown in FIG. 9 is displayed on the table screen 1306. Specifically, the screen imitating the baccarat table appears on the table screen 1306. In the baccarat table shown in connection with this embodiment, the areas 901, 902, and 903 respectively used for placing a bet in “TIE,” “BANKER,” and “PLAYER” are displayed for each of five players. The player points any of the areas 901, 902, and 903 by his hand corresponding to the pointer P, whereupon the area pointed at, where the player places a bet, among the areas “TIE,” “BANKER,” and “PLAYER” is input to the gaming machine 1300. The player can determine the number of chips/the amount of money/the number of credits to be bet by a bet button of a player terminal unit 1505 corresponding to the command receipt unit to be described later. Piles of chips owned by the respective players are also displayed on the table screen 1306. When the player points at any of the areas “BANKER,” “PLAYER,” and “TIE,” where a bet is placed, by the pointer P, the image appearing on the table screen 1306 is changed such that the chips, which are equal in number to the bet, are moved from the piles of chips of the player to the one of the areas 901, 902, and 903 specified by the pointer P.

The player operates the player terminal unit 1505, thereby specifying medals, which are of a plurality of previously-determined types and differ from each other in terms of values, and the number of medals; and can provide the gaming machine 1300 with the number of medals to be used for a bet by an instruction. In accordance with the instruction input by way of the player terminal unit 1505, the gaming machine 1300 displays the type of a medal and the number of medals, which comply with the previously-described input instruction, at a position on the table screen 1306 pointed by the player with use of the pointer P.

Turning back to FIG. 15, explanation of an exemplary electrical configuration of the gaming machine 1300 will be continued.

The game control unit 1502 is connected to a plurality of player terminals 1505₁ to 1505_{N}, which respectively correspond to command receipt unit. Each of the player terminals 1505 is a terminal machine having a bill delivery function of enabling the user to accept a pre-paid card or a credit card, to make the card handleable as credits (medals/coins) to be used in the gaming machine 1300, and to pay out credits (medals/coins) owned at that point in time in accordance with the payout command from the user and a bet input function of determining the number of bets/amounts of money/number of credits bet in the game. The player plays a game by the player terminal 1505 and the pointer P.

Next will be described processing for detecting the position on the table screen 1306 pointed by the player's hand corresponding to the pointer P.

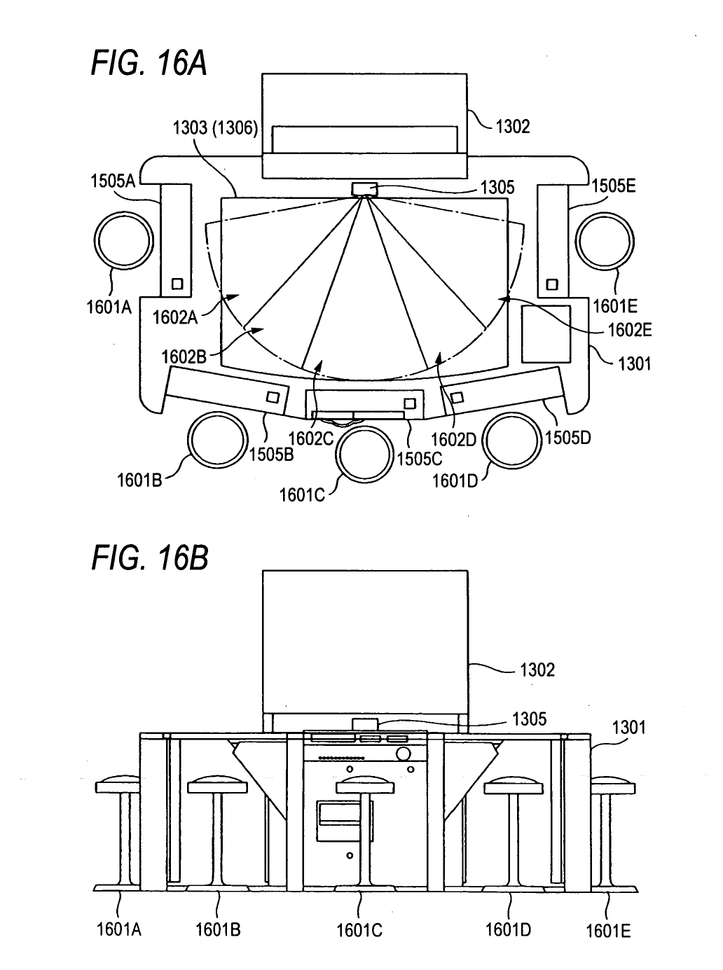

FIG. 16A is a plan view of the gaming machine 1300 when viewed from the above, showing that the sensor 1305 provided on the gaming machine 1300 scans the upper surface of the table screen 1306. FIG. 16B is a front view of the gaming machine 1300 corresponding to FIG. 16A.

The sensor 1305 emits scan light so as to pass over the table screen 1306. The sensor 1305 rotates the scan light from right to left or from left to right while taking the sensor 1305 as the center, to thus scan the entire upper surface of the table screen 1306. For instance, the sensor 1305 repeats emission of scan light and receipt of reflected light while turning the emission direction of scan light in increments of 0.5°.

In the present embodiment, the nature of the player who has pointed at the position can be determined by positional detection performed by the sensor 1305. The gaming machine 1300 is provided with stools 1601A to 1601E which enable seating of a maximum of five players. The area to which each of the players can stretch his hand is limited. The player terminals 1505A to 1505E embedded in the table unit 1301 are located ahead of the seated positions of the respective players. Each of the player terminals 1505A to 1505E is provided with a bet button, a cancel button, a payout button (not shown), and the like, and accepts an input command from the player.

Areas 1602A to 1602E shown in FIG. 16A are areas where the hands of the respective players can reach. For instance, the area 1602A is an area where the hand of the player utilizing the stool 1601A can reach. When a certain position on the table screen 1306 within the area 1602A has been pointed at, the sensor 1305 determines that the position is pointed at by the player utilizing the stool 1601A. The sensor 1305 determines which of the areas 1602A to 1602E the player has pointed at, based on the emission direction of scan light; determines the detected position as the position pointed at by the player assigned the area; and sends information (e.g., a player number) used for specifying the corresponding player to the position settlement determination unit 1506 along with the positional information.

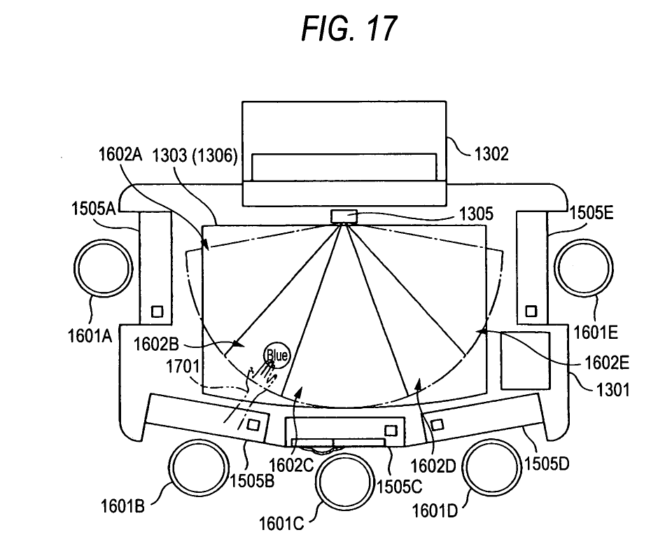

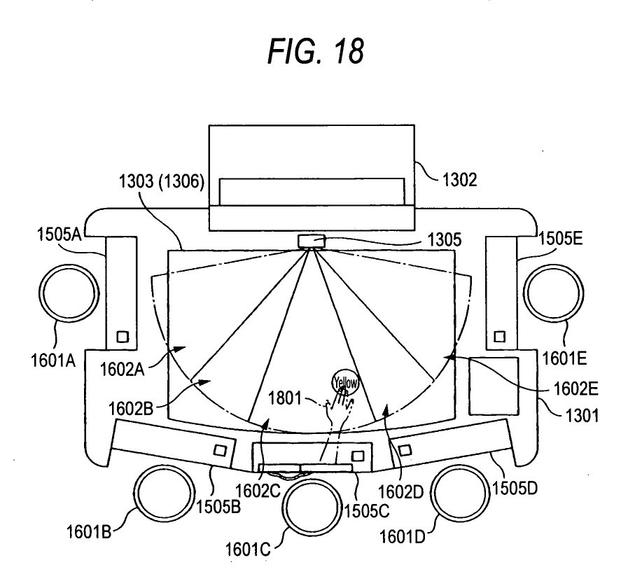

FIG. 17 shows a state where the player has pointed at a position in the area 1602B. The player points at a certain position within the area 1602B on the table screen 1306 by his hand 1701 corresponding to the pointer P. Based on the fact that the pointed position is within the area 1602B, the sensor 1305 determines that the pointed position is given by the player (the player who sits on the stool 1601B and utilizes the player terminal 1505B). FIG. 18 shows that the player has pointed at a position in the area 1602C. The player points at a certain position within the area 1602C on the table screen 1306 by his hand 1801 corresponding to the pointer P. Based on the fact that the pointed position is within the area 1602B, the sensor 1305 determines that the pointed position is given by the player (who sits on in the stool 1601C and utilizes the player terminal 1505C).

According to this method, colors (e.g., red, blue, yellow, green, and white) of chips used by the respective players are determined. Based on the detected positional information, the chips can be displayed at positions on the table screen 1306 indicated by the positional information.

The present embodiment has described the configuration where the entire area on the table screen 1306 is scanned by the single sensor 1305. However, the present invention is implemented even when there is adopted a configuration of a plurality of sensors 1305 being provided and scanning the areas on the table screen 1306 assigned to the respective sensors 1305. For instance, there may also be adopted a configuration of the two sensors 1305 being provided. One sensor 1305 is assigned to a right half of the area on the table screen 1306, and the other sensor 1305 is assigned to a left half of the area on the table screen 1306.

According to the position detection method, as compared with the configuration where the entire area is operated by a single sensor 1305, scanning of the entire area can be completed within a shorter period of time, and position detection can be performed within a shorter period of time. Further, processing capability of the sensor 1305 does not need to be high.

According to the position detection method, even when the plurality of players have concurrently pointed at the positions on the table screen 1306, the players assigned to the respective pointed positions can be ascertained.

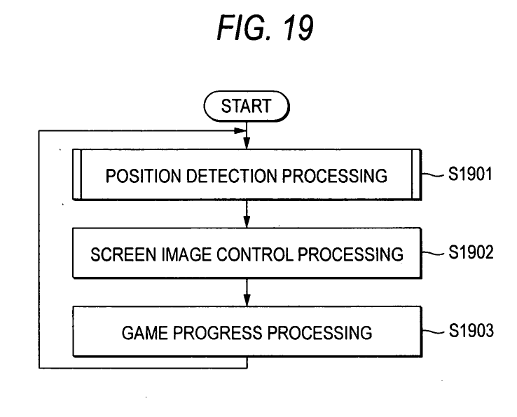

FIG. 19 is a flowchart showing an exemplary principal operation of the gaming machine 500.

First, the sensor 1305 and the position settlement determination unit 1506 perform position detection processing (step S1901). The sensor 1305 scans the table screen 1306 by scan light; determines whether or not the scan light has undergone reflection; measures the intensity and amount of reflected light when there is reflection; and specifies a direction and a distance, to thus compute a position.

Next, the sensor 1305 outputs the computed position as positional information (e.g., the xy coordinate values) to the position settlement determination unit 1506. The sensor 1305 may output player identification information (e.g., a player number) assigned to the positional information along with the positional information.

Position detection processing of the present embodiment is analogous to that described in connection with the first embodiment and comes to processing such as that shown in FIG. 11B, except that the sensor 1305 outputs positional information.

When position detection processing (step S1901) has been completed and the game control unit 1502 has received the settled position information or the unsettled position information from the position settlement determination unit 1506, the game control unit 1502 performs screen image control processing based on the settled position information/unsettled position information (S1902). Based on the settled position information/unsettled position information, the game control unit 1502 gives the screen display control unit 1501 a location where the image of the medal is to be displayed, by a command. In accordance with the command, the screen display control unit 1501 generates required image data, and the DLP 1402 projects the image data on the translucent screen 1303.

On receipt of the settled position information, the game control unit 1502 performs required game progress processing (step S1903). Specifically, based on the received positional information and the player's command, the game control unit 1502 determines the area where the player has placed a bet and the number of medals bet by the player; causes the game to further proceed; determines a win or a loss of the game of that player; pays out an award of medals or collects the medals according to the win or lose; and completes the game. Subsequently, processing again returns to step 1901, where a new game is initiated.

On receipt of the settled position information, the game control unit 1502 again returns to step 1901 without performing game progress processing, and continues the currently-played game.

### 3. Third Embodiment

A third embodiment of the present invention will now be described.

The third embodiment is proposed as a gaming machine utilizing the image display system 1 of the present invention. The external view of the gaming machine of the third embodiment is analogous to that of the gaming machine 500 of the first embodiment.

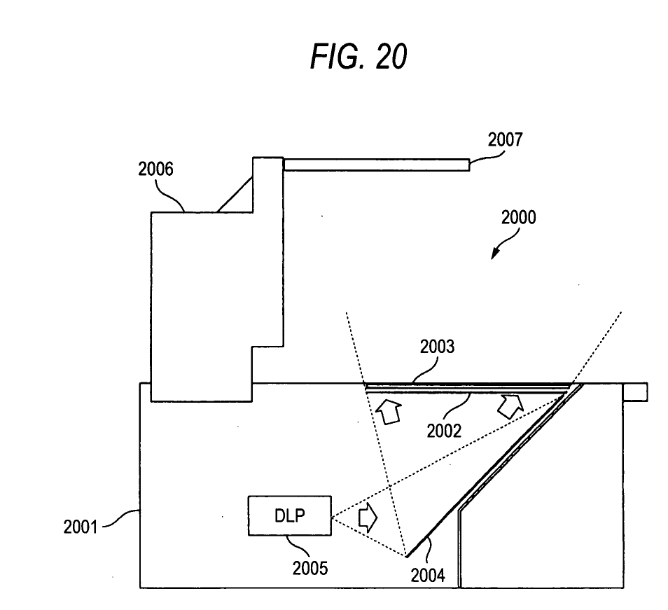

FIG. 20 is a view showing an exemplary layout of the optical system constituting the image display system 1 of the third embodiment stored in a table unit 2001 of a gaming machine 2000 according to the third embodiment.

The gaming machine 2000 has the table unit 2001, and a front display 2006 disposed at a rear end on the table unit 2001. A fluorescent lamp 2007 is provided so as to protrude from the front display 2006.

A translucent screen 2002 corresponding to the imaging unit 10 is fixed in the center of the table unit 2001 while being protected by a touch panel 2003 corresponding to the contact sensor 400. The touch panel 2003 is embedded in the table unit 2001 so that the player can touch an arbitrary position by the pointer P.

A mirror 2004 is provided in an inclined manner at a position beneath the translucent screen 2002. A digital liquid-crystal projector (hereinafter abbreviated as “DLP”) 2005 corresponding to the projection unit 20 is fixed at the position opposing the mirror 2004. The distance from the mirror 2004 to the DLP 2005 and the angle of a reflection plane of the mirror 2004 are adjusted such that the mirror 2004 reflects the image projected by the DLP 2005 toward the translucent screen 2002 to thus display the image in a desired size.

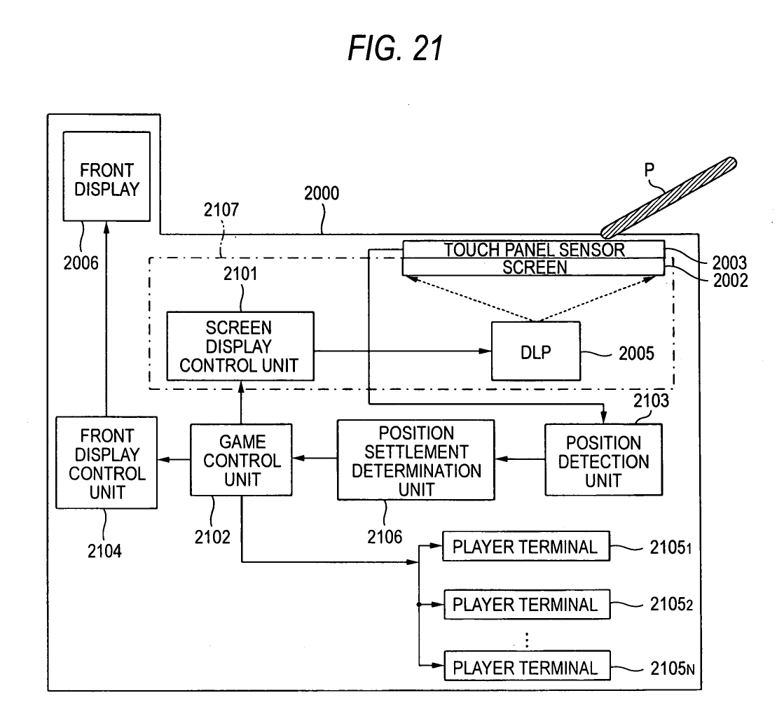

FIG. 21 is a block diagram showing an exemplary electrical configuration of the gaming machine 2000 according to a third embodiment. The example electrical configuration of the gaming machine 2000 of the third embodiment is essentially identical with that described in connection with the second embodiment, except that the gaming machine has the touch panel 2003 in stead of the sensor 1305. Specifically, the gaming machine 2000 is provided with the translucent screen 2002. The DLP 2005 optically projects on this translucent screen 2002 an image pertaining to a game.

The screen display control unit 2101, which corresponds to the video control unit 43, supplies image data (hereinafter called “front image data”) to the DLP 2005. The translucent screen 2002, the screen display control unit 2101, and the DLP 2005 constitute the table screen 2107 corresponding to the image display unit 70.

The position detection unit 2103, corresponding to the position detection unit 50, detects the position pointed at by the pointer P in accordance with the output from the touch panel 2003, and outputs positional information.

The position settlement determination unit 2106, corresponding to the position settlement determination unit 80, receives the positional information output from the position detection unit 2103; determines whether or not predetermined position settlement requirements are satisfied; and outputs to the game control unit 2102 the settled position information or the unsettled position information, as a result of determination.

The game control unit 2102, corresponding to the processor 60, has the function of controlling operation of the gaming machine 2000; issues to the screen display control unit 2101 a command pertaining to image data to be output and a timing at which image data are to be output; receives the positional information from the position detection unit 2103; and controls operation of the gaming machine 2000 in accordance with the positional information. In accordance with the command from the game control unit 2102, the front display control unit 2104 outputs image data pertaining to an image (hereinafter called “front image data”) to be displayed on the front display 2006.

The game control unit 2102 is connected to a plurality of player terminals 2105₁ to 2105_{N}. Each of the player terminals 2105 is a terminal machine having a bill delivery function of enabling the player to accept a pre-paid card or a credit card, to make the card handleable as credits (medals/coins) to be used in the gaming machine 2000, and to pay out credits (medals/coins) owned at that point in time in accordance with the payout command from the user and a bet input function of determining the number of bets/amounts of money/number of credits bet in the game. A console panel (omitted from the drawings) handles the bet input function, and the player terminal 2105 includes the console panel. The player plays a game by the player terminal 2105 and the pointer P.

The operation and advantage of the gaming machine 2000 according to the third embodiment are essentially identical with those of the gaming machines of the first and second embodiments.

The present invention is not limited solely to the gaming machine but can also be applied to an apparatus or a system which displays an image and accepts an input from the user by utilization of the displayed image, such as an image display system for presentation purpose, a demonstration device for sales promotion, and the like.

What is claimed is:

1. A gaming machine comprising:
a projection unit that projects an image;
an imaging unit on which the image projected by the projection unit is displayed;
a position detection unit that detects a position pointed by a pointer on the imaging unit;
a position settlement determination unit that determines whether or not a predetermined position settlement requirement is satisfied based on positional information indicating the position detected by the position detection unit; and
a processor that controls progress of a game based on a result of a determination made by the position settlement determination unit.

2. A gaming machine comprising:
a projection unit that projects an image;
an imaging unit on which the image projected by the projection unit is displayed and a pointer shade image that is a shade of a pointer used by a player for pointing a desired position is formed;
an image-capturing unit that captures the image and the pointer shade image on the imaging unit from an other side of the projecting unit with respect to the imaging unit and outputs image data indicating the image and the pointer shade image;
a position detection unit that detects a position pointed by the pointer based on the pointer shade image included in the image data;
a position settlement determination unit that determines whether or not a predetermined position settlement requirement is satisfied based on positional information indicating the position detected by the position detection unit; and
a processor that controls progress of a game based on a result of a determination made by the position settlement determination unit.

3. A gaming machine comprising:
a projection unit that projects an image for displaying a game table and medals;
an imaging unit on which the image projected by the projection unit is displayed, the imaging unit including a display surface;
a position detection unit that detects a position pointed by a pointer by scanning the display surface of the imaging unit;
a position settlement determination unit that determines whether or not a predetermined position settlement requirement is required based on positional information indicating the position detected by the position detection unit; and
a processor that controls progress of a game based on a result of a determination made by the position settlement determination unit.

4. The gaming machine according to claim 2,
wherein the position settlement determination unit stores the position detected by the position detection unit, and determines that the predetermined position settlement requirement is satisfied when a position newly detected by the position detection unit is determined to coincide with the stored position; and
wherein the processor stops the progress of the game until the position settlement determination unit determines that the position settlement requirement is satisfied.
